(19) United States
(12) Patent Application Publication
(10) Pub. No.: US 2011/0121706 A1
(43) Pub. Date: May 26, 2011

(54) LED package structure

(75) Inventors: Chao-Feng Lee, Changhua City (TW); Yu-Bing Lan, Banciao City (TW); Yin-Cheng Chao, Sanxia Township (TW)

(73) Assignee: Forward Electronics Co., Ltd., Taipei City (TW)

(21) Appl. No.: 12/923,995

(22) Filed: Oct. 20, 2010

(30) Foreign Application Priority Data
Nov. 26, 2009 (TW) 098222143

(51) Int. Cl. H01J 7/24

(52) U.S. Cl. 313/46

(57) ABSTRACT

A LED package structure includes a heatsink slug, a positive-electrode frame, a negative-electrode frame, and a LED module electrically connected with the positive-electrode frame and the negative-electrode frame, respectively. The heatsink slug is provided, on its surface, with a converged ladder-like recess, where the LED module is fixed on a plane deep inside the recess. Thereby, the fluorescent-colloidal-layer covering on the LED module has an increased thickness in a normal direction, making the color-lights emitted from the chips and from the fluorescent colloid in the space and in every direction able to be maintained so as to achieve a better spatial color uniformity.

### BACKGROUND OF THE INVENTION

1. Field of the Invention

The present invention relates to a light emitting diode (LED) package structure, and more particularly, to a LED package structure for improving spatial color uniformity.

2. Description of Related Art

Referring to FIG. 1, a cross-sectional view illustrating a conventional LED package structure, the LED package structure comprises a heatsink slug 1, a positive-electrode frame 2, a negative-electrode frame 3, and a LED module 4. The heatsink slug 1 is, at its top, formed with a cup-like recess 5 for receiving the LED module 4, where a plane for loading the LED module 4 is referred to as a “chip-fixing plane 6.” The LED module 4 may be a single- or a plural-phase electrically-connected LED chips, which, through two gold lines (not shown), can be electrically connected with the positive-electrode frame 2 and the negative-electrode frame 3.

There is a fluorescent colloidal layer 7 covering on the LED module 4, and that an insulating frame 8 envelopes and fixes part of the heatsink slug 1 and of the two frames 2,3.

Taking a widely-applied LED as an example, the LED module 4 may be a blue-light LED chip, and that the fluorescent colloidal layer 7 may be a yellow fluorescent colloidal layer laid with yellow phosphor (not shown). The theory for its function resides in using a short-wavelength blue-light to excite the phosphor for emitting a longer-wavelength yellow light, which then are mixed into a white light due to complement of colors.

However, there is a potential problem existing in the above-mentioned conventional LED package structure, namely, when a LED chip and a phosphor emit lights of different colors which are distributed non-uniformly, then a phenomenon of color shift will occur where colors are non-uniform. Since the LED chip relates to a one-side light source, a normal-direction component of blue light (as shown by arrow P) is greater than the components of other directions. This makes it necessary for the fluorescent colloidal layer 7 covering on the normal-direction component thicker than the components of other directions, so that a better color uniformity can be obtained. The measure for this achievement resides in applying the theory of surface tension such that when a silica gel is formed on the LED chip (gel-spotting method), a curved and convex gel surface can be formed.

Nevertheless, in case a dimension of the cup-like recess 5 becomes greater to a certain extent (for example, in an occasion where plural LED chips are received therein), the known gel-spotting method can hardly form an ideal curved and convex contour on the fluorescent colloidal layer 7, but rather a flat and slightly curved surface as shown. Under such circumstances, the fluorescent colloidal layer 7 covering on the normal-direction component, instead, becomes thinner than the components of other directions. This will result in a great amount of normal-direction blue light penetrating the fluorescent colloidal layer 7. Therefore, a higher color temperature occurs in the normal direction, while a lower color temperature at two sides and surroundings, and as such, a phenomenon of color halos is produced.

### SUMMARY OF THE INVENTION

An object of the present invention is to provide a LED package structure, comprising a heatsink slug, a positive-electrode frame, a negative-electrode frame, and a LED module. The LED module is electrically connected with the positive-electrode frame and the negative-electrode frame, respectively. The heatsink slug is provided, on its surface, with a converged ladder-like recess, where the LED module is fixed on a plane deep inside the recess.

Through the above-mentioned structure, as far as the LED module is concerned, the fluorescent-colloidal-layer-coverage, as compared with the conventional art, has an increased thickness in a normal direction, making a lower proportion of color-light emission for LED chips in the normal direction and a specific proportion of color-lights (i.e. the color-lights emitted from the chips and from the fluorescent colloid) in every direction able to be maintained so as to achieve a better spatial color uniformity.

The LED module may be a single LED chip, or plural LED chips electrically connected with one another, where the LED chips may be, for example, blue-light LED chip, green-light LED chips, red-light LED chips, or ultraviolet LED chips. The LED chips can be DC LED chips or AC LED chips.

Further, the heatsink slug may be of metal heatsink slug, for instance, a copper heatsink slug. Still further, the LED package structure, according to the present invention, may further comprise an insulating frame enveloping and fixing part of the heatsink slug, of the positive-electrode frame, and of the negative-electrode frame.

In addition, the ladder-like recess may be rectangular.

Other objects, advantages, and novel features of the present invention will become more apparent from the following detailed description when taken in conjunction with the accompanying drawings.

### BRIEF DESCRIPTION OF THE DRAWINGS

FIG. 1 is a cross-sectional view illustrating a conventional LED package structure;

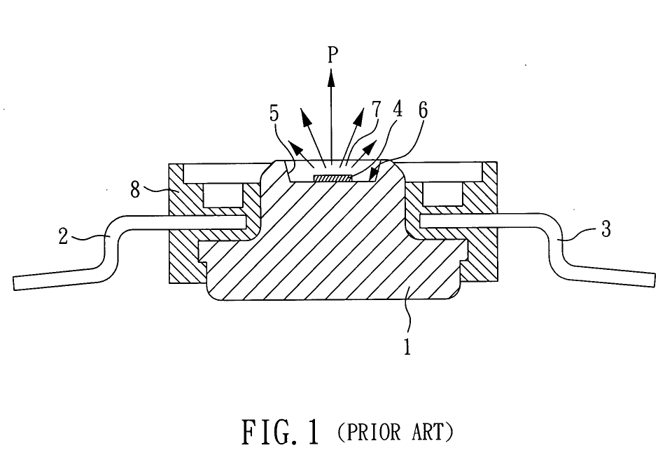

FIG. 2 is a perspective view illustrating a LED package structure according to a first embodiment of the present invention;

FIG. 3 is a cross-sectional view illustrating the LED package structure according to the first embodiment of the present invention; and

FIG. 4 is a cross-sectional view illustrating a LED package structure according to a second embodiment of the present invention.

### DETAILED DESCRIPTION OF THE PREFERRED EMBODIMENTS

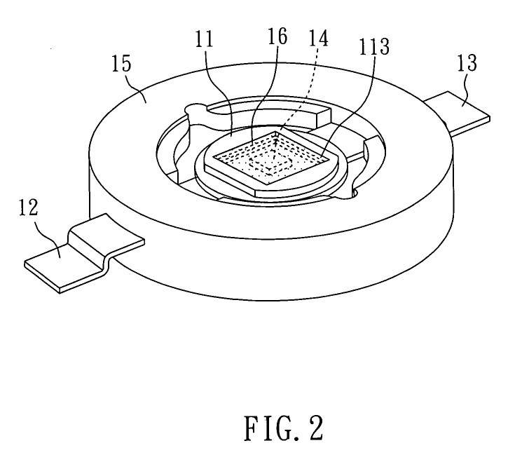

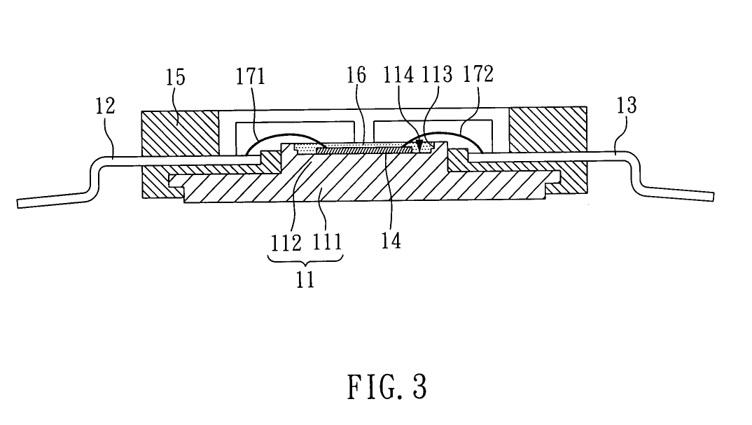

Referring to FIG. 2, a perspective view illustrating a LED package structure according to a first embodiment of the present invention, and to FIG. 3, a cross-sectional view illustrating the LED package structure, the LED package structure comprises a heatsink slug 11, a positive-electrode frame 12, a negative-electrode frame 13, a LED module 14, and an insulating frame 15. The heatsink slug 11 has a convex configuration, and includes a base 111 and a protrusion 112 extending upward from the base 111, wherein the protrusion 112 is provided, at its surface, with a converged ladder-like recess 113. In the present embodiment, the ladder-like recess 113 has a two-step structure, wherein each step is rectangular.

In the present embodiment, the LED module 14 relates to a single LED chip which, through two gold lines 171,172, is electrically connected with the positive-electrode frame 12 and the negative-electrode frame 13, respectively. The positive-electrode frame 12 and the negative-electrode frame 13 are then connected, respectively, with an outside circuit (not shown) for providing a power necessary for operation and control of the LED chip.

The LED chip is fixed on a plane at the bottom of the ladder-like recess 113 (referred to as a “chip-fixing plane 114). The heatsink slug 11 is made of, for example, copper, iron or other metal or alloy having a preferable thermal conductivity. Since the LED chip is fixed directly on metallic material (generally having a good thermal conductivity), the heat produced from operation can be dissipated, through the chip-fixing plane 114, to surroundings outside of the heatsink slug 11 so as to avoid any adverse effect to luminous efficiency of LED devices due to heat accumulated inside of the LED chip.

The LED chip is covered with a fluorescent colloidal layer 16, and relates to a blue-light chip. The fluorescent colloidal layer 16 relates to a yellow fluorescent colloidal layer. As such, the LED device can emit a white-light.

The insulating frame 15 surrounds the heatsink slug 11, and envelops part of the heatsink slug 11, of the positive-electrode frame 12, and of the negative-electrode frame 13, such that the three can be integrated as a unit. Part of the base 111 of the heatsink slug 11 exposes out of the insulating frame 15.

Given the above, it is understood that the LED chip is fixed in the bottom of a cup-like recess having a ladder-like configuration. Therefore, even if the fluorescent colloidal layer has a slightly convex, or even flat, contour (as shown), the LED device can have an improved illumination of spatial color uniformity. This is because the fluorescent colloidal layer, as compared with the conventional art, has an increased thickness in a normal direction, making a lower emission of blue-light in the normal direction and a uniform proportion for the blue-light/yellow-light in every direction able to be maintained.

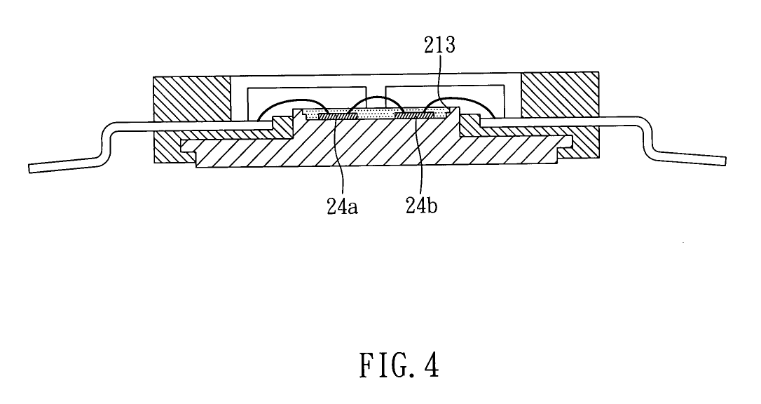

Now referring to FIG. 4, a cross-sectional view illustrating a LED package structure according to a second embodiment of the present invention, the second embodiment is featured in having a plurality of electrically-connected blue-light LED chips 24a,24b. Similarly, by means of a ladder-like recess 213, the blue-light emission of all the chips is lowered in the normal direction.

According to the present invention, the LED chips are not limited to be blue-light LED chips, others such as red-light or green-light LED chips can also be adopted. Besides, the LED chips can be DC LED chips or AC LED chips.

Although the present invention has been explained in relation to its preferred embodiments, it is to be understood that many other possible modifications and variations can be made without departing from the scope of the invention as hereinafter claimed.

What is claimed is:

1. A LED package structure, comprising:
a heatsink slug;
a positive-electrode frame;
a negative-electrode frame; and
a LED module, being electrically connected with the positive-electrode frame and the negative-electrode frame;
wherein the heatsink slug is provided, on its surface, with a converged ladder-like recess, and the LED module is fixed on a plane deep inside the recess.

2. The LED package structure as claimed in claim 1, wherein the LED module includes a blue-light LED chip.

3. The LED package structure as claimed in claim 1, further comprising an insulating frame enveloping and fixing part of the heatsink slug, of the positive-electrode frame, and of the negative-electrode frame.

4. The LED package structure as claimed in claim 1, wherein the heatsink slug is a metal heatsink slug.

5. The LED package structure as claimed in claim 1, wherein the ladder-like recess is rectangular.
